(19) United States
(12) Patent Application Publication
(10) Pub. No.: US 2012/0144182 A1
(43) Pub. Date: Jun. 7, 2012

(54) APPARATUS AND METHOD FOR FAST BOOTING BASED ON VIRTUALIZATION TECHNIQUE

(75) Inventors: Hyun Woo NAM, Yangju-si (KR); Su Hyun KIM, Seoul (KR)

(73) Assignee: Korea Institute of Science and Technology, Seoul (KR)

(21) Appl. No.: 13/312,920

(22) Filed: Dec. 6, 2011

(30) Foreign Application Priority Data
Dec. 7, 2010 (KR) 10-2010-0123923

(51) Int. Cl. G06F 9/00

(52) U.S. Cl. 713/2

(57) ABSTRACT

An apparatus for fast booting based on a virtualization technique includes: a hardware comprising a processor, a memory and a storage where a status information corresponding to an operating system (OS) is stored; and a virtual machine monitor (VMM) for interfacing between the OS and the hardware, wherein the VMM is operated by the processor and loads the status information on the memory. Herein, the status information may be pre-generated to include data in the memory in a state where the OS is completely booted.

### CROSS-REFERENCE TO RELATED APPLICATIONS

The present application claims priority under 35 U.S.C. §119 to Korean Patent Application No. 10-2010-0123923 filed on Dec. 7, 2010, in the Korean Intellectual Property Office, the disclosure of which is incorporated herein by reference in its entirety.

### BACKGROUND

1. Field

Embodiments relate to an apparatus and a method for fast booting based on a virtualization technique.

2. Description of the Related Art

Generally, after a power is applied, a computer consumes some time from the start of booting until its system is completely initialized. Therefore, even after applying a power, a user having an intention to use a specific application should wait for the completion of the booting to execute the application. In particular, in frequently-used embedded devices such as smart phones, portable multimedia player (PMP) and vehicle navigations, a user feels inconvenient if the device is not useable instantly after a power is applied.

In particular, embedded devices, which have been programmed in the firmware level in the past, start using a relatively large operating system (OS) such as Linux and Windows Mobile. However, in order to boot up such an operation system at an embedded device which is relatively slower than a personal computer (PC), the time taken for booting is longer, and for this reason, efforts are made to optimize the booting speed. However, such optimizing operation may reduce the booting time to some extent but is not able to give a great difference since the optimizing operation is just correcting codes so that unnecessary initiation processes are not performed.

FIG. 1 is a flowchart for illustrating a booting process of a conventional Linux operating system.

Referring to FIG. 1, after a power is applied to a system (S11), the basic input/output system (BIOS) of the system performs a Power-On Self-Test (POST) process (S12). In the POST process, the presence of peripheral devices installed to the system is searched, and an initializing operation required for each device is performed. If no problem is found in the initializing operation, a boot loader is then executed (S13). The boot loader determines an OS kernel for the booting. While the OS kernel is loaded, the boot loader initializes a process, a memory, and a data structure or the like used at the kernel and also initializes a device driver (S14). If the booting process is completed at the kernel, an Init process is generated to successively perform works recorded in /etc/inittab file (S15). Then, a console is loaded to complete the booting process (S16). After the console is loaded, the user may eventually perform a work such as execution of an application.

Since many initializing operations are performed in the booting process as described above, a considerable time is consumed until the user can actually perform an application. However, the POST step (S12) and the boot loader step (S13) do not form a great part of the booting time, and they do not have much room to be optimized. Since the following kernel loading step (S14) occupies most of the booting time, the operation for optimizing the kernel code is frequently performed. However, optimizing the kernel code has limits since there are not many unnecessary codes or optimizable elements. In addition, in order to perform optimization, a precondition that source codes of the OS should be open to the public is required, and the optimizing operations should be repeated whenever the OS kernel is upgraded to a new version.

Meanwhile, hibernation is a technique for reducing a waiting time of a user. The hibernation is a technique capable of stopping an OS in the level of OS, storing an image, and then restoring the stored image afterward. Specifically, all contents in a system memory are recorded in a non-volatile memory such as a hard disk before the power of the system is turned off, and then, if the computer is turned on again, the contents stored in the hard disk are loaded again to the memory and come to an original available state. The application which was previously used may be operated as is in the state where the application was stored.

Many existing operating systems support the hibernation function. For example, the hibernation function is called “hibernation mode” in Windows OS of Microsoft and is called “sleep” in Mac OS. However, since the hibernation function is implemented in the OS level, it may be used only when the OS provides the corresponding function. In the case of Linux OS, source codes are open to the public, and therefore a user may add a function. However, in the case where source codes are not open to the public such as OS of Microsoft, the hibernation function may be used only when the manufacturer of the OS provides the hibernation function. In particular, in case of OS of Windows Mobile or real time operating system (RTOS) used in other embedded devices, the hibernation function is often not provided. Therefore, a waiting time of a user is elongated.

### SUMMARY

According to an aspect of the invention, an apparatus and a method for fast booting based on a virtualization technique is provided. The apparatus and the method allows a user to use an application instantly after a power is applied, by excluding a booting process that takes a lot of time by means of a virtualization technique, and allows fast booting by using the virtualization technique even when an operating system does not provide a hibernation function.

An apparatus for fast booting based on a virtualization technique according to an embodiment may include: a hardware having a processor, a memory and a storage where a status information corresponding to an operating system (OS) is stored; and a virtual machine monitor (VMM) for interfacing between the OS and the hardware, wherein the VMM is operated by the processor and loads the status information on the memory.

Herein, the status information may be pre-generated to include data in the memory in a state where the OS is completely booted.

A method for fast booting based on a virtualization technique according to an embodiment may be used for booting an apparatus including hardware having a processor, a memory and a storage, and a VMM for interfacing between the hardware and an OS, wherein the storage stores a status information corresponding to the OS. The method may include: operating the VMM; and operating the OS by loading the status information on the memory by the VMM.

Herein, the status information may be pre-generated to include data in the memory in a state where the OS is completely booted.

### BRIEF DESCRIPTION OF THE DRAWINGS

FIG. 1 is a flowchart for illustrating a booting process of a conventional Linux operating system.

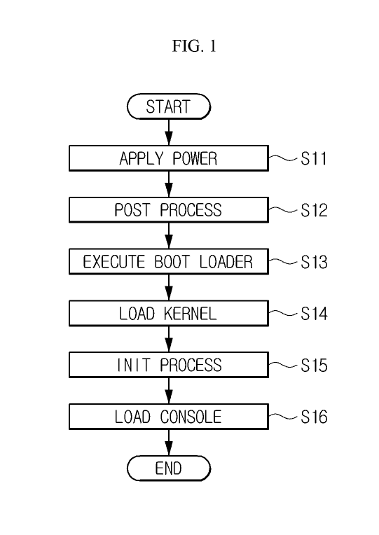

FIG. 2 is a flowchart for illustrating a booting process in a method for fast booting based on a virtualization technique according to an embodiment.

FIG. 3 is a diagram showing a level structure of an apparatus after booting is completed, in the apparatus for fast booting based on a virtualization technique according to an embodiment.

### DETAILED DESCRIPTION OF EMBODIMENTS

Hereinafter, embodiments will be described in detail with reference to the accompanying drawings. However, the present invention is not limited to the following embodiments.

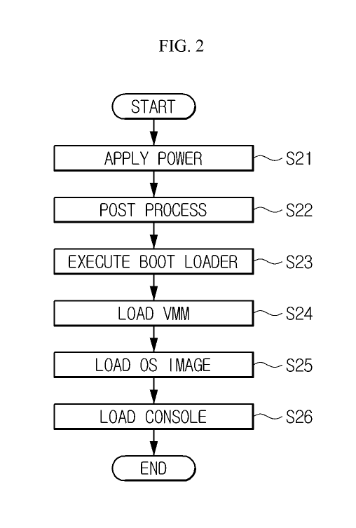

FIG. 2 is a flowchart for illustrating a booting process in a method for fast booting based on a virtualization technique according to an embodiment.

In the specification, the term “virtualization” means an operating system (OS) virtualization technique. The OS virtualization means a technique for the virtualization of hardware resources so that a plurality of operating systems may be operated in a single physical machine. The virtualization technique has a function of suspending the executing operating system and/or resuming the operating system. This function may be realized by storing status information of a currently executing operating system as an image of a file format and then resuming the status of the operating system by using the stored image file at a desired time later.

The embodiment described in this disclosure may have an aspect which is entirely hardware, partially hardware and partially software, or entirely software. In this disclosure, the terms “apparatus”, “interface”, “system” or the like means a computer-related entity such as hardware, a combination of hardware and software, software or the like. For example, in this disclosure, an apparatus, an interface, a system or the like may be a running process, a processor, an object, an executable file, a thread of execution, a program, and/or a computer, without being limited thereto. For example, both a computer and an application which is running on the computer may correspond to the apparatus, the interface, the system or the like in this disclosure.

The method for fast booting based on a virtualization technique according to an embodiment may be implemented to be executed by hardware including at least one component. Herein, the hardware may include a processor such as a central processing unit (CPU), a memory for providing a working area of the processor, and a storage for storing status information of the operating system. The storage may include a magnetic storage medium such as a hard disk and/or an optical storage medium such as compact disc (CD), digital versatile disc (DVD) or the like, without being limited thereto.

Referring to FIG. 2, in the method for fast booting based on a virtualization technique according to an embodiment, after a power is applied (S21), a basic input/output system (BIOS) of the system performs a Power-On Self-Test (POST) process (S22). In the POST process, the presence of peripheral devices installed to the system is searched, and an initializing operation required for each device is performed. If no problem is found during the initializing operation, a boot loader is then executed (S23).

At this time, unlike the conventional booting method, the boot loader moves to a virtual machine monitor (VMM) (S24) instead of executing a kernel of the operating system. In other words, the VMM is loaded on a memory before an operating system is loaded on the memory, and the VMM may perform interfacing between hardware and at least one guest OS. For example, the VMM may be implemented in a software form such as Ubuntu, VMware, Xen or the like, without being limited thereto.

The VMM may load the status information of the OS stored in the storage of the hardware on the memory (S25). The status information of the OS may include data which should be stored in the system memory in a state where an OS boots up and a booting process such as initialization of processes, memories and data structure and loading and initialization of device drivers is completed and stabilized. The status information may be pre-generated and stored in the storage of the hardware. For example, the VMM may stores the status information of the OS in the storage automatically or as a response to a specific user input in a state where the OS is normally booted. In addition, the status information may be stored in a format of an image file.

By loading the status information of the OS, stored in the format of the image file, into the memory, the OS may be resumed in a state where the booting process is completed. Then, the booting process may be completed by loading a console (S26).

When the above process is performed, the same effect as actually booting up an OS may be obtained by loading the status information of the OS, where all initializing processes such as initialization of device drivers or the like are completed, on a memory. As a result, the time consumed for initializing device drivers and initializing various kernel data structures and consumed for other initializing programs may be saved, and what is needed is only to load the status information of the booting-completed OS on the memory. Therefore, the time required after a power is applied to the apparatus till a user may actually execute an application is greatly reduced.

In addition, since the status information of the booting-completed OS is stored in the storage of the hardware in a format of an image file, even though the power supply is cut off and then applied again, fast booting is allowed. In addition, in a case where the OS is changed later due to OS upgrading or the like, the image file may be flexibly managed by updating the image file of the status information of the OS stored in the storage in accordance with the change of the OS. For example, the VMM may be configured to update the status information of the OS automatically or in response to a specific user input.

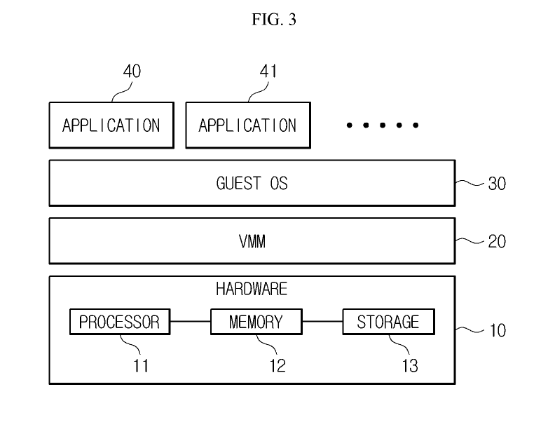

FIG. 3 is a diagram showing a level structure of the system after booting is completed, in the apparatus for fast booting based on a virtualization technique according to an embodiment.

Referring to FIG. 3, the apparatus for fast booting based on a virtualization technique may include hardware 10 and a VMM 20. A guest OS 30 may be operated on the VMM 20, and the VMM 20 may be operated to perform interfacing between the hardware 10 and the guest OS 30. Further, at least one application 40 and 41 may be executed on the guest OS 30. Even though FIG. 3 illustrates a single guest OS 30 executed by the VMM 20, a plurality of different operating systems may be executed by the VMM 20.

The hardware 10 may include a processor 11, a memory 12 and a storage 13. The status information of the OS including data, which should be loaded on the memory 12 when the guest OS 30 is normally booted, may be stored in the storage 13. For example, the status information may be stored in a format of an image file. As the VMM 20 loads the status information on the memory 12, the guest OS 30 may be resumed in an originally-stored state. Therefore, the same effect as actually booting up the guest OS 30 may be obtained only by loading the status information on the memory 12.

When booting is performed by using the fast booting apparatus configured as above, if a power is applied, the VMM 20 is loaded on the memory 12 prior to the OS. At this time, if the VMM 20 has a large capacity, the time taken for initializing the VMM 20 may be similar to that taken for booting the OS. Therefore, in order to increase the booting speed, the VMM 20 may be implemented with a light design so that the amount of data to be loaded on the memory 12 is as small as possible. Alternatively, the initializing process of the VMM 20 may be implemented to be performed fast by using a hibernation function. In other words, the status information of the VMM 20 is stored in the storage 13, and then, if a power is applied, the stored status information of the VMM 20 is loaded on the memory 12 so that the VMM 20 may be operated.

The apparatus and method for fast booting based on a virtualization technique described in the present disclosure may be implemented in a format of program codes (namely, commands) included in a concrete medium such as a floppy disc, CD-ROM, DVD, a hard drive, or other computer-readable recording media. The program codes are loaded on and executed by a device such as a computer, and the device herein corresponds to a device where the present invention is implemented.

According to an aspect of the present invention, a booting effect may be obtained without performing a kernel booting process, by storing the status information of a running OS in a disc in a format of an image file and then resuming the status information in a system memory in a virtualization level. In addition, fast booting is allowed even at an OA which does not support the hibernation function, and since it is not needed to modify source codes of the OS, the booting speed may be increased even when the source codes of the OS are not open to the public. As a result, the waiting time of a user till the device is actually available after a power is applied may be greatly reduced, and a power consumption may also be reduced.

While the present invention has been described with reference to the embodiments shown in the drawings, it will be apparent to those skilled in the art that they are just illustrative and various changes and modifications may be made thereto. However, such modifications should be considered as being included within the scope of the present invention. Therefore, the scope of the present invention should be defined by the appended claims.

What is claimed is:

1. An apparatus for fast booting based on a virtualization technique, comprising:
a hardware comprising a processor, a memory and a storage where a status information corresponding to an operating system (OS) is stored; and
a virtual machine monitor (VMM) for interfacing between the OS and the hardware, wherein the VMM is operated by the processor and loads the status information on the memory, and
wherein the status information is pre-generated to include data in the memory in a state where the OS is completely booted.

2. The apparatus for fast booting based on a virtualization technique according to claim 1,
wherein the status information includes a plurality of status information respectively corresponding to different operating systems, and
wherein the VMM loads one of the plurality of status information on the memory.

3. The apparatus for fast booting based on a virtualization technique according to claim 1,
wherein the VMM updates the status information stored in the storage after the status information is loaded on the memory.

4. The apparatus for fast booting based on a virtualization technique according to claim 1,
wherein the storage further stores a status information of the VMM, and
wherein the status information of the VMM is loaded on the memory when a power is applied.

5. The apparatus for fast booting based on a virtualization technique according to claim 1,
wherein the status information is stored in a format of an image file.

6. A method for fast booting based on a virtualization technique, the method for booting an apparatus comprising a hardware comprising a processor, a memory and a storage, and a VMM for interfacing between the hardware and an OS, wherein the storage stores a status information corresponding to the OS,
the method comprising:
operating the VMM; and
operating the OS by loading the status information on the memory by the VMM,
wherein the status information is pre-generated to include data in the memory in a state where the OS is completely booted.

7. The method for fast booting based on a virtualization technique according to claim 6,
wherein the status information includes a plurality of status information respectively corresponding to different operating systems, and
wherein the operating the OS comprises loading one of the plurality of status information on the memory by the VMM.

8. The method for fast booting based on a virtualization technique according to claim 6, further comprising:
updating the status information stored in the storage after the status information is loaded on the memory by the VMM.

9. The method for fast booting based on a virtualization technique according to claim 6,
wherein the storage further stores a status information of the VMM, and
wherein the operating the VMM comprises loading the status information of the VMM on the memory.

10. The method for fast booting based on a virtualization technique according to claim 6,
wherein the status information is stored in a format of an image file.
